(19) United States
(12) Patent Application Publication
(10) Pub. No.: US 2019/0313224 A1
(43) Pub. Date: Oct. 10, 2019

(54) AUTOMATED VEHICLE SYSTEMS AND CONTROL LOGIC FOR SMART DATA EXCHANGES USING ENHANCED BLOOM FILTERS

(71) Applicant: GM Global Technology Operations LLC, Detroit, MI (US)

(72) Inventors: Bo Yu, Troy, MI (US); Hariharan Krishnan, Troy, MI (US); Robert A. Bordo, Harrison Township, MI (US)

(73) Assignee: GM Global Technology Operations LLC, Detroit, MI (US)

(21) Appl. No.: 15/949,249

(22) Filed: Apr. 10, 2018

(51) Int. Cl. H04W 4/46; G06F 17/30; H04L 29/08

(52) U.S. Cl. CPC H04W 4/46; H04L 67/06; G06F 17/3023

(57) ABSTRACT

A method for executing a V2V data exchange includes determining if a host vehicle is communicatively connected to a seeder vehicle, and transmitting a prompt between the two vehicles to initiate a resource discovery process. The seeder vehicle wirelessly transmits to the host vehicle a Bloom filter with multiple file IDs mapped to a bit array. Each file ID has a corresponding file version number encoded to the bit array. The method then determines if a local file ID of an existing file stored via the host vehicle is a member of the Bloom filter; if so, the host vehicle determines if a remote file version number encoded to a counterpart file ID is newer than a file version number of the local file ID. If the remote file version number is newer, the seeder vehicle transmits the data file associated with the counterpart file ID to the host vehicle.

The present disclosure relates generally to networked data systems for provisioning information to motor vehicles. More specifically, aspects of this disclosure relate to wireless communication systems and control logic for optimizing data exchanges between vehicles during a peer-to-peer (P2P) resource discovery process.

Current production motor vehicles, such as the modern-day automobile, are originally equipped with or retrofit to include various onboard electronic devices for transferring information to, from, and within the vehicle. In automotive applications, for example, onboard vehicle devices may exchange content that is based on data from a local device, such as a networked vehicle controller, a distributed sensor, or a human machine interface (HMI). Resident vehicle communication systems may also exchange data with a remote node, such as a cloud-computing data center, a GPS navigation transceiver, or a satellite broadcast service. Some devices are able to receive data from a distributed computer network—the most ubiquitous being the global Internet—over a wireless fidelity (WiFi) system, cellular network, or other wireless communications technology. Data may also be collected by a centralized server system from a group of participating vehicles, and analyzed to identify traffic and road conditions for dissemination to other vehicles within a designated region. Original equipment manufacturers (OEM) are also moving towards interconnected “talking” cars that exchange information with one another using vehicle-to-vehicle (V2V) communication.

With the continued evolution of V2V communications, manufacturers are exploiting peer-to-peer data exchange techniques to facilitate the expedited propagation of vehicle calibration information, diagnostic and prognostic data, vehicle recall alerts, etc. A host vehicle that desires to access information stored on another vehicle may issue a prompt to the other vehicle with a request to access the data. After authenticating the host vehicle's credentials to access the requested information, the other vehicle may transfer the data to the host vehicle, e.g., via a dedicated shortrange communications (DSRC) system. Connectivity bandwidth and latency in V2V communications systems, however, typically limit the sizes and transfer speeds of data packets that may be transmitted between peers. Transferring large data packets over a short timeframe may overburden the bandwidth of the DSRC channel. This issue is exacerbated when transferred data is duplicative of information that the requesting vehicle already has stored in local memory. Moreover, the time during which two vehicles are within range to communicate with one another may be limited; if large amounts of data are transferred, portions of the data may either not be transferred or may not be transferred in its entirety.

### SUMMARY

Disclosed herein are automated vehicle-to-vehicle (V2V) data exchange systems and attendant control logic, methods for operating and methods for constructing such systems, and motor vehicles employing an enhanced Bloom Filter and hash function for member identification and version number comparison during a peer-to-peer (P2P) data exchange. By way of example, there is presented a novel protocol for assisting a host vehicle (first node) with discovering available files and file versions of data stored on a first-hand or second-hand seeder vehicle (second node) during a P2P resource discovery process. The nodes employ an enhanced Bloom Filter with a compact data structure and hash function mapping for membership tests and file version number comparison to help enable widespread sharing of distributed resources. Bloom filters are time and space-efficient data structures for probabilistic representation of a data set to support membership queries (e.g., test whether or not a particular element is a member of a respective data set). A Bloom filter may be employed for cache sharing, query filtering and routing, compact representation of a batch file, and other suitable functions.

During a collaborative Certificate Revocation List (CRL) distribution process, for example, a security certificate management system (SCMS) implements a Misbehavior Authority (MA) module that periodically generates CRL files to catalog misbehaving vehicles (e.g., a vehicle attempting to illicitly hack into another vehicle's onboard computing network) and corrupted vehicles (e.g., a vehicle infested with malware). A subgroup of vehicles—labelled “first-hand seeder vehicles”—downloads the CRL files, e.g., via WiFi, LTE or RSU, from the SCMS, and then distributes the files to other vehicles via collaborative V2V communications. This process helps to enable vehicles without cellular or WiFi connectivity to receive these CRL lists, while concomitantly reducing costs associated with cellular data usage by limiting cellular data transfer to a restricted group of vehicles. CRL files may include a digital certificate issued by a Public-Key-Infrastructure (PKI) to establish a chain of trust; file encryption, however, may be waived to support wider and faster distribution of the files.

P2P file distribution oftentimes involves exchanging data files generated with different versions or data files earmarked for a limited subset of vehicles (e.g., vehicles of a specific make, model, geographic location, etc.). To help ensure only pertinent, non-overlapping data is transmitted, P2P file distribution may commence with first generating a Bloom filter that is representative of the data files available for retrieval from the seeder vehicle. A seeder vehicle may respond to receipt of a broadcast “hello” beacon by mapping a set of members (i.e., file IDs) with encoded version data, e.g., added as a multi-bit binary sequence, to a multi-bit array using a hash function. This bit array is wirelessly communicated from the seeder vehicle to one or more host vehicles to support expeditious, reduced-bandwidth P2P resource discovery. The host vehicle then retrieves its own file IDs, and maps each file ID to the Bloom filter using the attendant hashing technique to determine whether or not a file ID for a local data file is a member of the bit array (member identification). For each local file ID that is a member, the host vehicle will then retrieve from the Bloom filter the encoded version number for the counterpart remote file ID, and then determine whether or not the encoded version number is newer than the version number associated with the local file ID (version number comparison). Using a Bloom filter with a multi-bit array allows the receiving vehicle to “know” the available data files as well as the respective contents of each file. From this list, the host vehicle identifies the file or files that are not duplicative yet relevant to that vehicle; the seeder and host vehicles then exchange the actual file contents.

Aspects of this disclosure are directed to V2V data exchange techniques and computer-executable algorithms for motor vehicles. For instance, a method is presented for executing a V2V data exchange between a first (host) vehicle and a second (seeder) vehicle. Generally speaking, a single vehicle may function as both a seeder vehicle, i.e., to distribute data to another vehicle, and as a host vehicle, i.e., to receive data distributed from another vehicle. Conversely, at least some V2V system architectures may designate only a select vehicle or subgroup of vehicles as seeders, while the remainder of vehicles are designated as hosts. This representative method includes, in any order and in any combination with any of the disclosed features and options, determining if a wireless communications device of the host vehicle is communicatively connected to a wireless communications device of the seeder vehicle. If the host and seeder vehicles are within range to communicate, a prompt is transmitted from the host vehicle to the seeder vehicle (or vice versa) to initiate a resource discovery process in order to retrieve data stored via a resident memory device of the seeder vehicle for storage via a resident memory device of the host vehicle.

Upon commencement of the resource discovery process, a Bloom filter may be generated via the seeder vehicle, and subsequently transmitted from the seeder vehicle to the host vehicle. This Bloom filter includes a set of remote file IDs mapped to a bit array, e.g., via a suitable hashing technique, wherein each remote file ID has a corresponding remote file version number encoded to the bit array, e.g., as a multi-bit binary sequence. The resident vehicle controller of the host vehicle will then determine whether or not a local file ID of an existing file stored via the resident memory device of the host vehicle is a member of the received Bloom filter. The local file ID is a member if a counterpart remote file ID is already mapped to the Bloom filter bit array. In response to the local file ID being a member of the received Bloom filter, the host vehicle will determine if the remote file version number encoded to the counterpart remote file ID is newer than a local file version number associated with the local file ID. Responsive to the remote file version number being newer than the local file version number, the seeder vehicle will transmit a data file associated with the counterpart remote file ID to the host vehicle.

Other aspects of the present disclosure are directed to motor vehicles employing an enhanced Bloom Filter and hash function for member identification and version number comparison during a V2V data exchange. As used herein, the term “motor vehicle” may include any relevant vehicle platform, such as passenger vehicles (internal combustion engine, hybrid, full electric, fuel cell, etc.), commercial vehicles, industrial vehicles, tracked vehicles, off-road and all-terrain vehicles (ATV), farm equipment, boats, airplanes, etc. In an example, a motor vehicle is presented that includes a vehicle body with a powertrain, a resident memory device, a resident wireless communications device, and a resident vehicle controller, all of which are mounted to the vehicle body. The vehicle controller is operatively connected to the memory device and the wireless communications device.

Continuing with the above example, the resident vehicle controller is programmed to determine if the resident wireless communications device is communicatively connected to a wireless communications device of a seeder vehicle, and transmit a prompt to the seeder vehicle to initiate a resource discovery process to retrieve data stored via a memory device of the seeder vehicle for storage via the resident memory device. The resident vehicle controller then receives, from the seeder vehicle via the resident wireless communications device, a Bloom filter with a set of remote file IDs mapped to a bit array. Each remote file ID has a corresponding remote file version number encoded to the bit array. The resident vehicle controller is programmed to determine whether or not a local file ID of an existing file stored via the resident memory device is a member of the received Bloom filter and, in response to the local file ID being a member of the received Bloom filter, determine if the remote file version number encoded to the counterpart remote file ID is newer than a local file version number associated with the local file ID. In response to the remote file version number being newer than the local file version number, the resident vehicle controller downloads to the resident memory device a data file that is associated with the counterpart remote file ID and stored in the memory device of the seeder vehicle.

For any of the disclosed embodiments, determining whether or not a local file ID is a member of a received Bloom filter may include: applying a hash function to map the local file ID to the bit array of the Bloom filter; and confirming that the hash function maps the local file ID to the same array position or positions of the bit array as the counterpart remote file ID. Responsive to a determination that a local file ID is not a member of a received Bloom filter, it may be determined if another local file ID of another existing file stored via a resident memory device of a host vehicle is a member of the received Bloom filter. Likewise, in response to a determination that the remote file version number is not newer than a local file version number, it may be determined if another local file ID of another existing file stored via the resident memory device of the host vehicle is a member of the received Bloom filter. As indicated above, the bit array is comprised of a series of multi-bit array positions; each remote file version numbers is encoded as a multi-bit binary sequence that assigned to one or more of these array positions. One or more of these encoded multi-bit binary sequences may be assigned to multiple ones of these multi-bit array positions.

For any of the disclosed embodiments, the method/programmed vehicle controller may: identify a set of data files stored in a resident memory device of a seeder vehicle; generate a Bloom filter; and map each of the remote file IDs to the bit array of the Bloom filter with the corresponding remote file version number encoded to the bit array. Optionally, the remote file IDs and their corresponding encoded file version numbers may be generated in real-time. Mapping a remote file ID to a bit array may include applying a hash function that assigns the corresponding encoded remote file version number to one or more designated array positions of the bit array. Each remote file version number may be encoded as a multi-bit binary sequence that is assigned to one or more of the Bloom filter's array positions.

For any of the disclosed embodiments, it may be determined if a new data file is received via the wireless communications device of the seeder vehicle. The new data file may be accompanied by meta data (e.g., with a new file ID and a new file version number). In response to receiving the new data file, the corresponding new file ID may be mapped to the bit array of the Bloom filter with the new file version number encoded to the bit array. A resident vehicle controller, e.g., of a host vehicle, may select existing files, one-by-one, from a set of existing files stored via a resident memory device of that vehicle. Prompts to initiate a resource discovery process may be transmitted from the host vehicle to the seeder vehicle, or vice versa, in response the host and seeder vehicles establishing a wireless connection with each other.

The above summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative motor vehicle with a network of in-vehicle controllers, sensors and communication devices for executing a vehicle-to-vehicle data exchange in accordance with aspects of the present disclosure.

FIG. 2 is a diagrammatic illustration of a representative peer-to-peer resource discovery and data exchange procedure employing an enhanced Bloom filter and multi-bit array in accordance with aspects of the present disclosure.

FIG. 3 is a flowchart for a Bloom filter bit array generation protocol that may correspond to instructions executed by onboard or remote control-logic circuitry, programmable electronic control unit, or other computer-based device or network of devices in accord with aspects of the disclosed concepts.

FIG. 4 is a flowchart for a Bloom filter bit array parsing protocol that may correspond to instructions executed by onboard or remote control-logic circuitry, programmable electronic control unit, or other computer-based device or network of devices in accord with aspects of the disclosed concepts.

The present disclosure is amenable to various modifications and alternative forms, and some representative embodiments have been shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed by the appended claims.

### DETAILED DESCRIPTION

This disclosure is susceptible of embodiment in many different forms. There are shown in the drawings and will herein be described in detail representative embodiments of the disclosure with the understanding that these illustrated examples are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including” and “comprising” and “having” shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a normal driving surface, for example.

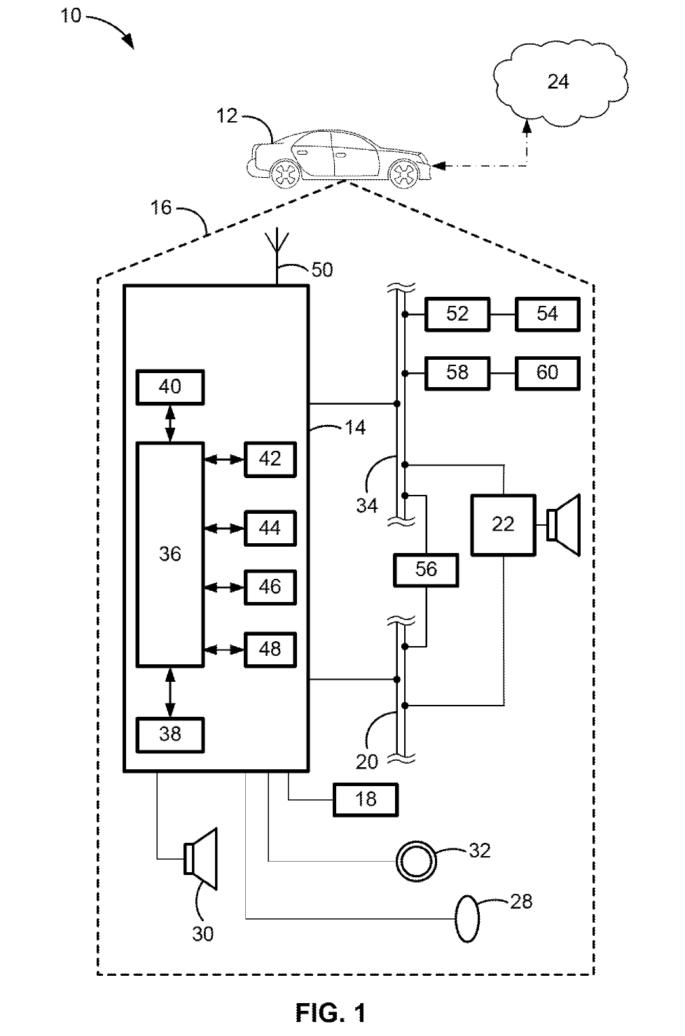

Referring now to the drawings, wherein like reference numbers refer to like features throughout the several views, there is shown in FIG. 1 a representative automobile, which is designated generally at 10 and portrayed herein for purposes of discussion as a sedan-style passenger vehicle. Packaged within a vehicle body 12 of the automobile 10, e.g., distributed throughout the different vehicle compartments, is an onboard network of electronic devices, such as the assorted computing devices and control units described below. The illustrated automobile 10—also referred to herein as “motor vehicle” or “vehicle” for short—is merely an exemplary application with which aspects and features of this disclosure may be practiced. In the same vein, implementation of the present concepts for the specific vehicle-to-vehicle (V2V) system architectures illustrated in the drawings should also be appreciated as an exemplary application of the concepts and features disclosed herein. As such, it will be understood that aspects and features of this disclosure may be applied to other V2V system architectures, and implemented for any logically relevant type of motor vehicle. Moreover, only select components of the vehicle 10 have been shown and will be described in additional detail herein. Nevertheless, the motor vehicles and network architectures discussed herein may include numerous additional and alternative features, and other available peripheral components, for example, for carrying out the various methods and functions of this disclosure. Lastly, the drawings presented herein are not necessarily to scale and are provided purely for instructional purposes. Thus, the specific and relative dimensions shown in the drawings are not to be construed as limiting.

The representative vehicle 10 of FIG. 1 is originally equipped with a vehicle telecommunication and information (colloquially referred to as “telematics”) unit 14 that wirelessly communicates (e.g., via cell towers, base stations and/or mobile switching centers (MSCs), etc.) with a remotely located or “off-board” cloud computing system 24. Some of the other vehicle hardware components 16 shown generally in FIG. 1 include, as non-limiting examples, a display device 18, a microphone 28, a speaker 30, and input controls 32 (e.g., buttons, knobs, switches, touchpads, keyboards, touchscreens, etc.). Generally, these hardware components 16 enable a user to communicate with the telematics unit 14 and other systems and system components within the vehicle 10. Microphone 28 provides a vehicle occupant with means to input verbal or other auditory commands; the vehicle 10 may be equipped with an embedded voice processing unit utilizing human/machine interface (HMI) technology. Conversely, speaker 30 provides audible output to a vehicle occupant and may be either a stand-alone speaker dedicated for use with the telematics unit 14 or may be part of a vehicle audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switch, internal/external parallel/serial communication bus, a local area network (LAN) interface, a controller area network (CAN), a media oriented system transfer (MOST), a local interconnection network (LIN) interface, and the like. Other appropriate communication interfaces may include those that conform with ISO, SAE, and IEEE standards and specifications. The network connection interface 34 enables the vehicle hardware 16 to send and receive signals with each other and with various systems and subsystems both outside or “remote” from the vehicle body 12 and within or “resident” to the vehicle body 12. This allows the vehicle 10 to perform various vehicle functions, such as controlling vehicle steering, governing operation of the vehicle's transmission, controlling engine throttle, engaging/disengaging the brake system, and other automated driving functions. For instance, telematics unit 14 receives and/or transmits data to/from a protection system ECU 52, an engine control module (ECM) 54, an infotainment application module 56, sensor interface module(s) 58, and assorted other vehicle ECUs 60, such as a transmission control module (TCM), a climate control module (CCM), a brake system module (BCM), etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to one or more electronic memory devices 38, each of which may take on the form of a CD-ROM, magnetic disk, IC device, semiconductor memory (e.g., various types of RAM or ROM), etc., and a real-time clock (RTC) 42. Long-range vehicle communication capabilities with remote, off-board networked devices may be provided via one or more or all of a cellular chipset/component, a navigation and location chipset/component (e.g., global positioning system (GPS)), or a wireless modem, all of which are collectively represented at 44. Close-range wireless connectivity may be provided via a short-range wireless communication device 46 (e.g., a Bluetooth® unit or near field communications (NFC) transceiver), a dedicate short-range communications (DSRC) component 48, and/or a dual antenna 50. It should be understood that the vehicle 10 may be implemented without one or more of the above listed components, or may include additional components and functionality as desired for a particular end use. The various communications devices described above may be configured to exchange data between vehicles as part of a periodic beacon message that is broadcast in a V2V communication system or a vehicle-to-everything (V2X) communication system, e.g., Vehicle-to-Infrastructure (V2I), Vehicle-to-Pedestrian (V2P), or Vehicle-to-Device (V2D).

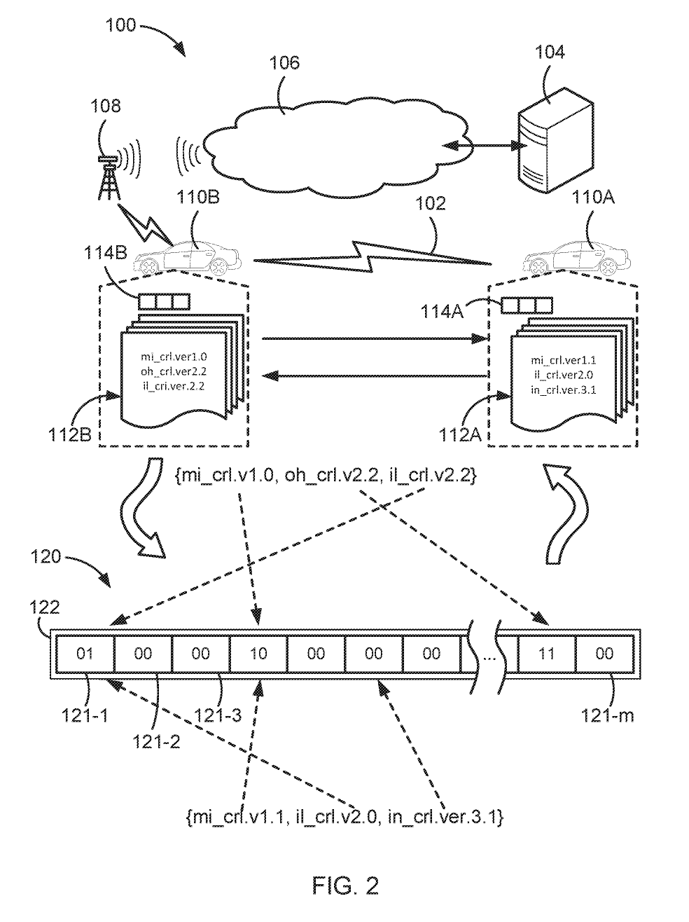

FIG. 2 is a diagram of a wireless vehicular communications system 100 portraying a first (host) vehicle 110A driving into proximity with and “talking” to a second (seeder) vehicle 110B. The motor vehicles 110A and 110B may be any type of commercially available vehicle with V2V communications capabilities. By way of non-limiting example, it is envisioned that any of the features disclosed above with reference to the vehicle 10 of FIG. 1 can be incorporated, singly or in any combination, into the vehicles 110A and 110B of FIG. 2, and vice versa. The first and second vehicles 110A, 110B may exchange wireless messages, data, etc., with each other over a respective inter-vehicle communication network (e.g., DSRC) 102. While illustrating a single host vehicle 110A communicating with a single seeder vehicle 110B, each motor vehicle may communicate with any number of remote vehicles that are within broadcast range of that vehicle for exchanging information and data. One or both of the vehicles 110A, 110B may communicatively couple to a remote host system 104 or a cloud computing system 106 via one or more wireless communication networks 108. The host system 104 may be implemented as a high-speed server computing device or a mainframe computer capable of handling bulk data processing, resource planning, and transaction processing. Network 108 may be any available type of network, including a combination of public distributed computing networks (e.g., Internet) and secured private networks (e.g., local area network, wide area network, virtual private network), and may include wireless and wireline transmission systems (e.g., satellite, cellular network, terrestrial networks, etc.).

Also shown in FIG. 2 are examples of data files that may be maintained by each vehicle 110A, 110B and provisioned across the wireless vehicular communication systems 100. A first set of categorized data files 112A is stored in a resident memory device 114A of the first (host) vehicle 110A, whereas a second set of categorized data files 112B is stored in a resident memory device 114B of the second (seeder) vehicle 110B. Each set of data files 112A, 112B may include data relating to vehicle position, route planning, vehicle kinematics/dynamics, vehicle calibration information, diagnostic and prognostic data, vehicle recall alerts, traffic events, road conditions, collisions, current conditions that could result in a collision, etc. In addition to advance warning for environmental awareness conditions, line of sight object tracking, non-line of sight tracking, and path prediction may be determined through V2V communications. Health status information that denotes the reliability and/or accuracy of data obtained by the vehicles may also be communicated. It should be recognized that the categories of data referenced herein are purely representative, and any suitable scheme may be utilized for categorizing, storing and transmitting this information.

Due to the overwhelming amount of information that may be stored in either vehicle 110A, 110B, wirelessly transmitting all data files and/or the corresponding meta data for such data files to another vehicle during a P2P resource discovery process may be limited or otherwise prevented by the communication channel's bandwidth, bit rate, latency, or transaction timeframe. To help ensure that all pertinent, non-overlapping data is successfully transmitted during P2P file distribution, it may be advantageous to initially send only that information which is necessary for a host vehicle to identify what pertinent and non-overlapping data, if any, is available on a given seeder vehicle. V2V data exchange systems, methods and vehicles described herein employ control logic for ascertaining which records to transmit without initially sending the full meta data or entire contents of the files. Seeder vehicles, whether a first-hand or a second-hand seeder vehicle, may then effectively communicate only those records that meet query requirements.

With continuing reference to the representative wireless vehicular communications system 100 architecture of FIG. 2, each vehicle 110A, 110B maintains a list of meta data for the files 112A, 112B currently existing on that vehicle. By way of non-limiting example, file meta data may include: a file name (e.g., “mi_crl”, “oh_crl” and “il_crl”), which may indicate a file's contents (e.g., a Certificate Revocation List (“crl”); a file version (e.g., versions “1.0”, “2.0”, “2.2”, etc.), a file creation time (such as “03/18/2018 9 am”); a file size (such as 12345 bytes), etc. When a first vehicle 110A encounters a second vehicle 110B, one or both vehicles 110A, 110B may systematically, responsively, randomly and/or periodically broadcast a hello beacon or other prompt to initiate a resource discovery process. In this process, either vehicle 110A, 110B may function as a seeder vehicle or a host vehicle or both; thus, the terms “host vehicle” and “seeder vehicle” are used primarily to clarify a source and a destination for a particular V2V file exchange. In effect, one vehicle 110B may share locally stored files with the other vehicle 110A; meanwhile, that vehicle 110B may also receive files from the other vehicle 110A or any other vehicle that is within range to communicate.

Once a first vehicle 110A discovers a new, neighboring vehicle 110B, e.g., by receiving and accepting the other vehicle's hello beacon, one or both vehicle's 110A, 110B may confirm the other's credentials and concomitantly agree to transmit data from the second vehicle 110B, acting as a seeder, to the first vehicle 110A, acting as a host. In this example, the seeder vehicle 110B responsively generates, in real-time, a Bloom filter 120 based on the data files 112B currently stored in resident memory device 114B. The Bloom filter 120 may start with a bit array 122 of m multi-bit array positions 121-1, 121-2, 121-3 . . . 121-m, all of which may initially be set to zero-zero (00) or other series of zeros, e.g., depending on the number of bits per array position. A number of k different hash functions may be defined, with each hash function correlating a respective hash element to one of the m array positions with a uniform distribution. Each file ID is then mapped to the bit array 122 in accordance with its respective hash function or functions; the bits at these positions are set to a multi-bit binary sequence corresponding to a time scale (“version freshness number”) or other encoded parameter associated with that file ID. Once the Bloom filter 120 is complete, it is broadcast by the seeder vehicle 110B to one or more host vehicles 110A.

To determine whether or not a particular data file is within the set, the host vehicle 110A feeds the file ID to each of the corresponding k hash functions to locate k array positions; if all the bits at these array positions are not zero-zero (00), then the element is in the set. Conversely, if any of the bits at these positions are zero-zero (00), then the element is not in the set. A length of the bit array (i.e., the total number m of array positions) may be selectively modified to achieve a desired false positive probability. The false positive probability may be further optimized as a joint function of a content similarity between the first vehicle 110A and the second vehicle 110B, and an expected encounter time of duration between the two vehicles. The hash function or functions utilized during a V2V file exchange may include (or consist of) a mutually agreed upon hash function or set of hash functions between the host and seeder vehicles 110A, 110B. For example, the seeder vehicle 110B may identify the file IDs and corresponding contextual data (e.g., version number, release date, allocation data, etc.) for the second set of data files 112B, then hash each file ID of the second set into a Bloom filter bit array using a mutually identified hash function. The host vehicle 110A, upon receiving the Bloom filter, hashes the file ID of each local data file in the first set of data files 112A into the bit array using the same mutually identified hash function. background

According to the illustrated example, the seeder vehicle 110B identifies the contextual information for each data file 112B stored in resident memory 114B—in this case, the files' time scale data—converts the contextual information into a decipherable multi-bit binary sequence, and then maps this encoded identifier to the Bloom filter's bit array 122 in place of the standard single-integer placeholder common to single-bit arrays of other Bloom filters. The vehicular communications system 100 may use a calibrated set of two-bit identifiers to represent file version freshness: (1) “01” to represent a file that was created less than 24 hours ago; (2) “10” to represent a file that was created more than 24 hours, but less than a week ago; and (3) “11” to represent a file that was created more than a week, but less than a month ago. For the data file “il_crl.ver2.2” of FIG. 2, the seeder vehicle 110B may determine that the current time is “03/19/18 08:11 hours” and the file create time is “03/18/2018 09:30 hours”; as such, version 2.2 of this file was created less than 24 hours ago and, thus, corresponds to identifier “01”. Seeder vehicle 110B may concurrently determine that the data file “mi_crl.ver1.0” was created roughly 47 hours ago (corresponding to identifier “10”), and data file “oh_crl.ver2.2” was created about 9 days and 14 hours ago (corresponding to identifier “11”). The above steps may be performed contemporaneously via the host vehicle 110A for the first set of data files 112A stored in resident memory device 114A.

For at least some embodiments, the encoded identifier may comprise greater than two integers, e.g., to represent more complex contextual information for the stored data files. By way of example, and not limitation, a vehicle may maintain two databases of CRL files, e.g., one for the U.S.A. and one for Canada. If the vehicle is travelling in the U.S.A., the vehicle will generate a Bloom filter based on CRL files stored in the US Database (e.g., mi_crl, ohio_crl, il_crl, etc.). Contrastingly, if the vehicle is travelling in Canada, it will generate a Bloom filter based on CRL files stored in the CA Database (Ontario_crl, Quebec_crl, Montreal_crl, etc.). To help ensure that a host vehicle accesses the appropriate database, the multi-bit array positions of the Bloom filter will store a 3-digit binary sequence that starts with “1” for all CRL files stored in the US Database and “0” for all CRL files stored in the CA Database.

After encoding the contextual information for the individual files contained in the second set of data files 112B, the seeder vehicle 110B uses a hash function for determining to which element or elements a file should be mapped in the bit array 122. Suppose seeder vehicle 110B uses three hash functions for file “mi_crl.ver1.0”: hash1(‘mi_crl’)=3, hash2(‘mi_crl’)=6, hash3(‘mi_crl’)=10; in this instance, the file identifier “10” is mapped to three array positions: element three, element six, and element ten. As shown, seeder vehicle 110B uses a single hash function for each file: hash_function(‘mi_crl’)=4, so the file ‘mi_crl’ is mapped to the 4th element in the Bloom filter 120 as “10”; hash_function(‘il_crl’)=1, so the file ‘il_crl’ is mapped to the 1st element in the Bloom filter 120 as “01”; and hash_function(‘oh_crl’)=m−1, so the file ‘oh_crl’ is mapped to the m−1 element in the Bloom filter 120 as “11”. It is envisioned that the vehicle 110B uses greater than one hash function for each file and, optionally, uses the same or a different number of hash functions for each file.

Once the host vehicle 110A receives the Bloom filter 120 generated by the seeder vehicle 110B, host vehicle 110A iterates through its list of file meta data, including the corresponding file ID and contextual data for the data file set 112A, and determines whether or not seeder vehicle 110B has a newer version of any of these locally stored files. Continuing with the example illustrated in FIG. 2, the host vehicle 110A determines whether or not the seeder vehicle 110B has a newer version for locally stored files “mi_crl.ver.1.1” and “il_crl.ver.2.0”. Host vehicle 110A first executes a member identification procedure by using the matching hash functions to map each locally stored file to the Bloom filter 120. For instance, file “mi_crl.ver.1.1” is mapped to the bit array 122 using hash_function(‘mi_crl’), whereas file “il_crl.ver.2.0” is mapped to the bit array 122 using hash_function(‘il_crl’). The multi-bit binary sequences stored at the first and fourth elements of the bit array 122 confirms that these two locally stored files are members of the Bloom filter 120. Data file set 112A may also contain data file “in_crl.ver.3.1” that is mapped to the sixth element of the bit array 122 using a hash_function(‘in_crl’); in this instance, the zero-zero (00) binary sequence stored in the sixth element denotes that this particular locally stored file is not a member of the Bloom filter 120. Since the “in_crl” is not a member, it can be assumed that the seeder vehicle 110B does not store a counterpart “in_crl” file. As indicated above, a file ID may have multiple hash functions and, thus, may be mapped to multiple array positions; when conducting member identification, if a single one of these array positions is filled with all zeros, it is assumed that the file ID is not a member.

After completing membership identification for the locally stored data file set 112A, the host vehicle 110A executes version number comparison by evaluating the contextual data for each membership-confirmed locally stored file against the contextual data for the corresponding remotely stored file to determine which version is newer. Suppose host vehicle 110A knows that locally stored data file “mi_crl.v1.1” was created roughly 12 hours ago (corresponding to identifier “01”), whereas locally stored data file “il_crl.v2.0” was created roughly two months ago (corresponding to identifier “11”). Host vehicle 110A calls up the two-bit identifier stored in hash_function(‘mi_crl’)=4 of the bit array 122, which is identifier “10”, and the two-bit identifier stored in hash_function(‘il_crl’)=1 of the bit array 122, which is identifier “01”. Once retrieved, the host vehicle 110A finds that the fourth element of the Bloom filter 120, which is 10, indicates that the remotely stored file is an older version of “mi_crl” than the locally stored version, which has a freshness value of “01”. In light of this determination, the host vehicle 110A does not download the older version of the “mi_crl” file from the seeder vehicle 110B. Conversely, host vehicle 110A finds that the first element of the Bloom filter 120, which is 01, indicates that the remotely stored file is a newer version of “il_crl” than the locally stored version, which has a freshness value of “10”. In this instance, the host vehicle 110A may initiate content transmission from seeder vehicle 110B with an upper layer protocol for the newer version of data file “il_crl”.

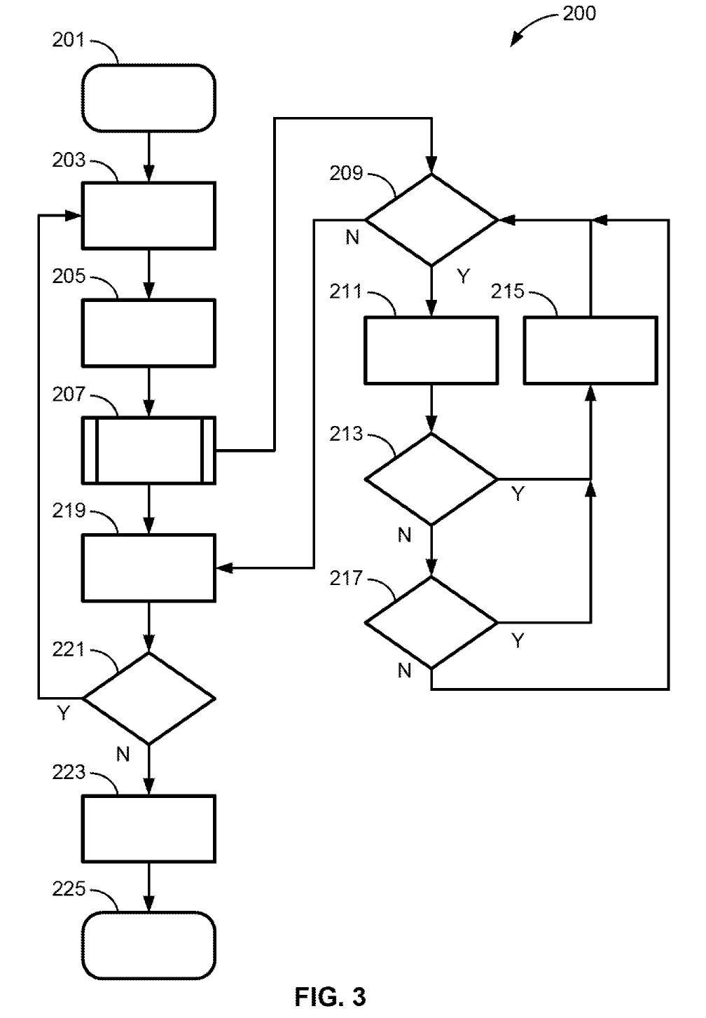

With reference now to the flow chart of FIG. 3, an improved method or control strategy for generating a Bloom Filter bit array by a seeder/transmitter vehicle, such as automobile 10 of FIG. 1 or motor vehicles 110A and 110B of FIG. 2, is generally described at 200 in accordance with aspects of the present disclosure. Some or all of the operations illustrated in FIG. 3 and described in further detail below may be representative of an algorithm that corresponds to processor-executable instructions that may be stored, for example, in main or auxiliary or remote memory, and executed, for example, by an on-board or remote controller, processing unit, control logic circuit, or other module or device, to perform any or all of the above or below described functions associated with the disclosed concepts. It should be recognized that the order of execution of the illustrated operation blocks may be changed, additional blocks may be added, and some of the blocks described may be modified, combined, or eliminated.

Method 200 begins at terminal block 201 with processor-executable instructions for a programmable controller or control module to call up an initialization procedure for a protocol to govern a P2P resource discovery process between two motor vehicles. In an example, the initialization procedure at block 201 may be initiated each time one motor vehicle encounters another motor vehicle that is compatible for executing a V2V wireless data exchange. As described above with respect to the representative system architecture of FIG. 2, a transmitter vehicle (e.g., seeder vehicle 110B) with one or more locally stored data files allocated for broadcast may call up and execute method 200 in direct response to encountering a new neighboring vehicle (e.g., host vehicle 110A). At process block 203, the filter-generating vehicle cycles through a list of meta data for locally stored files to identify which files to encode and map. It may be desirable, for at least some applications, to employ a seeder vehicle's resident vehicle controller, such as CPU 36 and/or processors 40 of vehicle 10 of FIG. 1, to identify a set of data files stored in resident memory, such as memory devices 38, for sharing with one or more host vehicles. Optionally, the vehicle may be provided with a call-up table that enumerates a predetermined list of files for sharing each time the vehicle encounters another vehicle; the vehicle may retrieve and serially iterate through the list at block 203.

After determining which files may be shared, the method 200 continues to process block 205 with processor-executable instructions to encode each file's contextual data into a bit value for mapping to the Bloom filter. According to the illustrated example of FIG. 2, the seeder vehicle 110B converts each file's time scale data into a multi-bit binary sequence based on the current time (e.g., retrieved from RTC 42) and the issuance time of that file (e.g., received from the file's meta data). Seeder vehicle 110B of FIG. 2, for example, may encode each file ID in real-time or, alternatively, may receive encoded file information from an off-board source, such as remote host system 104 or cloud computing system 106. To help ensure the most up-to-date content during the data exchange, the resident vehicle controller of the seeder vehicle may generate the remote file IDs and corresponding remote file version numbers for the data file set in real-time. In addition, every time a seeder vehicle receives a newer version of a file or a replacement for a file, the presently stored file may be deleted such that the seeder vehicle may generate a new Bloom filter that represents only the latest release of files.

With continuing reference to FIG. 3, the method 200 continues to predefined operation block 207 and employs a suitable Bloom filter (BF) algorithm to map each file to a single element or multiple elements of a bit array of the Bloom filter. There are many Bloom filter variants and multiple Bloom filter algorithms envisioned for mapping file IDs and their corresponding encoded file versions to a suitable Bloom filter bit array. For instance, a first type of Bloom filter algorithm may be employed to optimize mapping each file's calibrated two-bit identifier to a single element in the array, whereas a second type of Bloom filter algorithm may be employed to optimize mapping each file ID to multiple elements in the array, as described above. Moving to the branch flowchart in FIG. 3, the method 200 determines at decision block 209 whether or not there are more elements to be processed for a selected file ID. For instance, a single hash function may be used to map a selected file ID to a single element; as such, there is only one element that needs to be processed for this file ID. By contrast, if a selected file ID is using multiple hash functions to map that file ID to multiple elements, then the method 200 will iterate through each element to ensure the file ID is mapped to all corresponding bit array positions. If a single hash function is being used and/or there is only one final element to be processed for multiple hash functions, the method 200 maps the encoded file version bit value of a given file ID to a single/final array position at process block 207, confirms that there are more elements to be processed at block 209 (decision block 209=NO), and then returns to process block 219.

Where multiple hash functions are used for a given file ID, the method 200 uses an initial hash function (e.g., hash1(‘mi_crl’)=3) to map the encoded file version bit value (e.g., “10”) for that file ID (e.g., “mi_crl”) to the corresponding array position (element 3) of the Bloom filter, e.g., at process block 207. Responsive to a determination that there are more elements to be processed (decision block 209=YES), method 200 continues to process block 211 and uses a subsequent hash function (e.g., hash2(‘mi_crl’)=6) to identify the next corresponding array position (element 6) for that file ID (e.g., “mi_crl”). At decision block 213, the method 200 determines if this array position is empty (e.g., is element 6 set to zero-zero (00)). If this array position is in fact empty (decision block 213=YES), the method 200 continues to process block 215 and fills this array position (element 6) with the encoded file version bit value (e.g., “10”) for the selected file ID (e.g., “mi_crl”). Conversely, in response to a determination that this array position (element 6) is not empty (decision block 213=NO), the method 200 continues to decision block 217 to determine if the encoded file version bit value of the selected file ID is newer than the bit value currently stored at this array position. If it is not (decision block 217=NO), the method 200 returns to and repeats decision block 209. However, if the encoded file version bit value is newer than the stored bit value (decision block 217=YES), the method 200 will responsively fill the array position (element 6) with the newer encoded file version bit value at process block 215.

After inserting the encoded file version bit value of a given file ID into the BF array at all corresponding array positions, as described above, the method 200 proceeds to decision block 221 to determine if there are any more files that should be mapped to the Bloom filter. If there are remaining files that need to be encoded to the Bloom filter (decision block 221=YES), the method 200 returns to process block 203 and iterates back through the above-described steps. Conversely, upon determining that there are no more remaining files (decision block 221=NO), the method 200 proceeds to process block 223 and broadcasts the Bloom filter. The method 200 may thereafter terminate at terminal block 225.

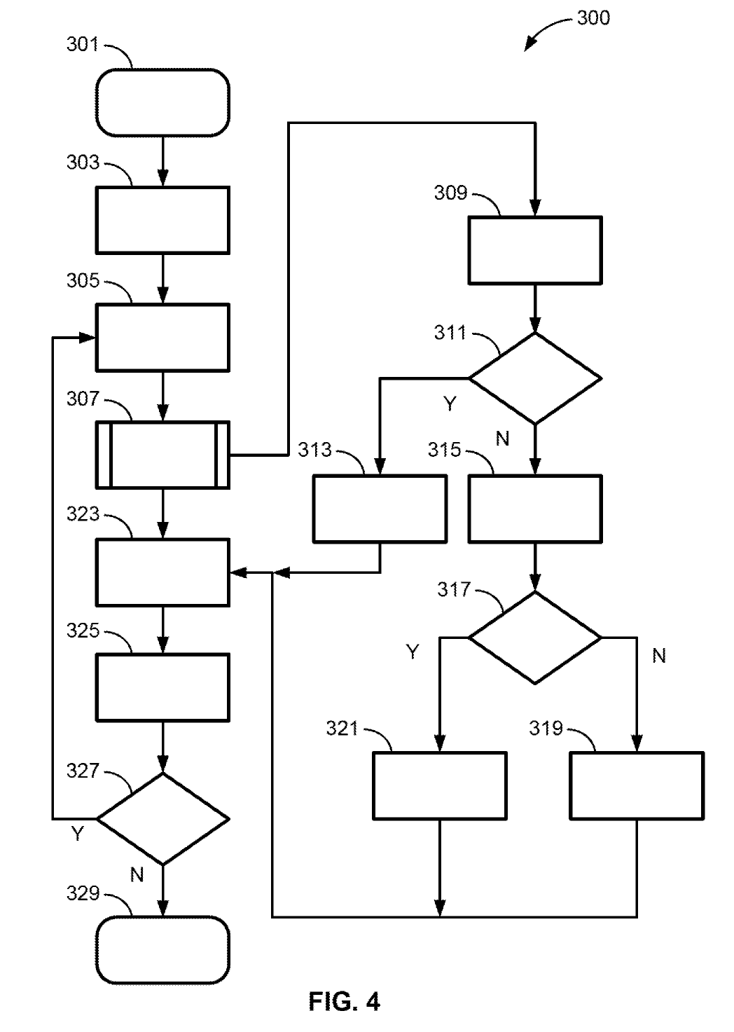

With reference now to the flow chart of FIG. 4, an improved method or control strategy for parsing a received Bloom Filter bit array by a motor vehicle, such as automobile 10 of FIG. 1 or motor vehicles 110A and 110B of FIG. 2, is generally described at 300 in accordance with aspects of the present disclosure. Some or all of the operations illustrated in FIG. 4 and described in further detail below may be representative of an algorithm that corresponds to processor-executable instructions that may be stored, for example, in main or auxiliary or remote memory, and executed, for example, by an on-board or remote controller, processing unit, control logic circuit, or other module or device, to perform any or all of the above or below described functions associated with the disclosed concepts. It should be recognized that the order of execution of the illustrated operation blocks may be changed, additional blocks may be added, and some of the blocks described may be modified, combined, or eliminated. For instance, the methods 200 and 300 of FIGS. 3 and 4 may be combined into a single control logic protocol for executing a V2V data exchange between one or more host vehicles and one or more seeder vehicles.

Method 300 begins at terminal block 301 with processor-executable instructions for a programmable controller or control module to call up an initialization procedure for a protocol to initiate a P2P resource discovery process between two motor vehicles. Referencing back to the example of FIG. 2, a first (host) vehicle 110A is shown driving into proximity with a second (seeder) vehicle 110B; the host vehicle 110A may emit a prompt to the seeder vehicle 110B to initiate communications. If the two vehicles 110A, 110B are within broadcast range, e.g., of each other's respective DSRC component 48, a resident vehicle controller, such as CPU 36 of FIG. 1, may determine that a wireless connection has been established between the two vehicles. The host vehicle 110A may responsively transmit a prompt to initiate a resource discovery process to retrieve data stored via the resident memory device of the seeder vehicle for storage via the resident memory device of the host vehicle.

Contemporaneous with or after completing the protocol at terminal block 301, the method 300 continues to process block 303 with processor-executable instructions for a receiver vehicle, e.g., host vehicle 110A of FIG. 2, to receive a Bloom filter. As indicated above, a wireless communications device of a seeder vehicle 110B may transmit a Bloom filter to a host vehicle 110A, e.g., at process block 223 of FIG. 3. Once received, a resident vehicle controller of the receiving vehicle selects a file ID for an existing file that is part of a file set stored in resident memory, at process block 305. As explained above, each vehicle maintains a list of file meta data (e.g., file name, file size, file version, file origin, etc.); the host vehicle picks a file from the list of file meta data. After a local file is selected, the method continues to predefined operation block 307 to determine whether or not the selected local file ID is a member of the received Bloom filter (e.g., a counterpart remote file ID is already mapped to the received Bloom filter's bit array) and, if so, whether or not the local file ID has a newer counterpart file stored on the seeder vehicle.

Moving to the branch flowchart in FIG. 4, the method 300 proceeds to process block 309 and retrieves all of the mapped elements from the received Bloom filter for the corresponding remotely stored data file. If a single hash function is being used for a select file ID, only one single array position needs to be identified and the stored bit value retrieved for that select file ID. However, if multiple hash functions are used for a select file ID, then multiple array positions need to be identified with their respective bit values retrieved for that select file ID. Once retrieved, the method 300 determines at decision block 311 whether or not at least one of the retrieved elements is empty. In other words, if a single one of the array positions identified at process block 309 is set to zero-zero, the select file is not a member of the received Bloom filter and, thus, a counterpart file does not exist on the remote (seeder) vehicle. Responsive to a determination that at least one element is in fact empty (decision block 311=YES), the method 300 continues to operation block 313 and sets a flag to memorialize that the member identification test results indicate that a counterpart to the selected local file does not exist on the remote vehicle. The method 300 would thereafter return to process block 323 without retrieving a counterpart file from the remote vehicle, then proceed to process block 325 to notify other modules of the membership test and version test results, and then to decision block 327 to determine if there are any more locally stored files that should complete the membership test and version test for the received Bloom filter.

When the method 300 determines that none of the retrieved elements are empty (decision block 311=NO), the vehicle will execute the instructions of process block 315 to identify the oldest element among all of the mapped elements retrieved at process block 309. Continuing with the example above, the host vehicle's 110A CPU 36 will retrieve three calibrated two-bit identifiers: one for element 3 (e.g., value “01”), one for element 6 (e.g., value “01”), and one for element 10 (e.g., value “10”). In the representative case, the “oldest” of the retrieved elements is “10”, which represents a file that was created more than 24 hours ago, but less than a week ago. At decision block 317, the method 300 determines if the local file is newer than the remote file by comparing the encoded file version bit value for the locally stored select file with the bit value retrieved at process block 315. By way of non-limiting example, the local file may have a freshness value of 01; in this case, the host vehicle concludes that the remote vehicle file's freshness number of 10 is an older file version number. Method 300 responds to a determination that the local file is not newer than the remote file (decision block 317=NO) by setting a flag at process block 319 to indicate that a newer counterpart file does exist on the remote vehicle, returns to process block 323 with a request to retrieve the newer counterpart file from the remote vehicle, and then proceeds to process block 325 to notify other modules of the membership test and version test results. Conversely, if the local file is newer than the remote file (decision block 317=YES), the method 300 responds by setting a flag at process block 321 to indicate that a newer counterpart file does not exist on the remote vehicle, returns to process block 323 without retrieving a counterpart file from the remote vehicle, and then proceed to process block 325 to notify other modules of the membership test and version test results. After the method 300 iterates through all relevant files on the host vehicle (decision block 327=NO), the method 300 may terminate at terminal block 329.

Aspects of this disclosure may be implemented, in some embodiments, through a computer-executable program of instructions, such as program modules, generally referred to as software applications or application programs executed by an onboard vehicle computer or a distributed network of resident and remote computing devices. The software may include, in non-limiting examples, routines, programs, objects, components, and data structures that perform particular tasks or implement particular abstract data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by remote-processing devices that are linked through a communications network. In a distributed-computing environment, program modules may be located in both local and remote computer-storage media including memory storage devices. Aspects of the present disclosure may therefore, be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, or method disclosed herein may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in an available manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

1. A method for executing a vehicle-to-vehicle (V2V) data exchange between a host vehicle and a seeder vehicle, the host and seeder vehicles each including respective resident memory and wireless communications devices, the method comprising:
determining if the wireless communications device of the host vehicle is communicatively connected to the wireless communications device of the seeder vehicle;
transmitting a prompt between the host and seeder vehicles to initiate a resource discovery process to retrieve data from a set of remote files stored via the resident memory device of the seeder vehicle for storage via the resident memory device of the host vehicle;
transmitting, from the wireless communications device of the seeder vehicle to the host vehicle, a Bloom filter with a set of remote file IDs mapped to a bit array, each of the remote file IDs corresponding to a respective one of the remote files and having a corresponding remote file version number encoded as a multi-bit binary sequence mapped to the bit array;
determining whether or not a local file ID of an existing file stored via the resident memory device of the host vehicle is a member of the Bloom filter, the local file ID being a member of the Bloom filter if the multi-bit binary sequence of a counterpart one of the remote file IDs of a counterpart one of the remote files is mapped to and fills each array position of the bit array assigned to the local file ID according to a calibrated hash function;
in response to the local file ID being a member of the Bloom filter, determining if the remote file version number encoded to the counterpart remote file ID and mapped to the bit array of the Bloom filter is newer than a local file version number associated with the local file ID; and
in response to the remote file version number being newer than the local file version number, transmitting the counterpart remote file associated with the counterpart remote file ID and stored in the resident memory device of the seeder vehicle to the host vehicle.

2. The method of claim 1, wherein determining whether or not the local file ID is a member of the Bloom filter includes:
applying the calibrated hash function to map the local file ID to the bit array of the Bloom filter; and
confirming that the hash function maps the local file ID to each array position of the bit array as the counterpart remote file ID.

3. The method of claim 1, further comprising, in response to a determination that the local file ID is not a member of the Bloom filter, determining if another local file ID of another existing file stored via the resident memory device of the host vehicle is a member of the Bloom filter.

4. The method of claim 1, further comprising, in response to a determination that the remote file version number is not newer than the local file version number, determining if another local file ID of another existing file stored via the resident memory device of the host vehicle is a member of the Bloom filter.

5. The method of claim 1, wherein the bit array is comprised of a series of multi-bit array positions, and wherein each of the corresponding remote file version numbers is encoded as the multi-bit binary sequence assigned to one or more of the multi-bit array positions.

6. The method of claim 5, wherein at least one of the encoded multi-bit binary sequences for the corresponding remote file version of at least one of the remote file IDs is assigned to multiple ones of the multi-bit array positions.

7. The method of claim 1, further comprising:
identifying, responsive to the prompt via a resident vehicle controller of the seeder vehicle prior to transmitting the Bloom filter, the set of remote data files stored in the resident memory device of the seeder vehicle;
generating, in real-time via the resident vehicle controller of the seeder vehicle, the Bloom filter; and
mapping each of the remote file IDs of the remote files to the bit array of the Bloom filter with the corresponding remote file version number encoded as the multi-bit binary sequence to the bit array.

8. The method of claim 7, further comprising generating, in real-time, the remote file IDs and the corresponding remote file version numbers for the set of remote data files via the resident vehicle controller of the seeder vehicle.

9. The method of claim 7, wherein mapping each of the remote file IDs to the bit array includes applying the calibrated hash function that assigns the corresponding remote file version number for each of the remote file IDs to one or more designated array positions of the bit array.

10. The method of claim 9, wherein the bit array is comprised of a series of multi-bit array positions, and wherein each of the corresponding remote file version numbers is encoded as the multi-bit binary sequence assigned to one or more of the multi-bit array positions.

11. The method of claim 10, wherein at least one of the encoded multi-bit binary sequences for the corresponding remote file version numbers for at least one of the remote file IDs is assigned to multiples ones of the multi-bit array positions.

12. The method of claim 1, further comprising:
determining if a new data file is received via the wireless communications device of the seeder vehicle, the new data file including a new file ID and a new file version number; and
in response to receiving the new data file, mapping the new file ID to the bit array of the Bloom filter with the new file version number encoded to the bit array.

13. The method of claim 1, further comprising selecting, via a resident vehicle controller of the host vehicle, the existing file from a set of existing files stored via the resident memory device of the host vehicle.

14. The method of claim 1, wherein the prompt is transmitted from the host vehicle to the seeder vehicle in response to a determination that the wireless communications devices of the host and seeder vehicles are communicatively connected to each other.

15. A motor vehicle comprising:
a vehicle body;
a resident memory device mounted to the vehicle body;
a resident wireless communications device mounted to the vehicle body; and
a resident vehicle controller mounted to the vehicle body and operatively connected to the resident memory device and the resident wireless communications device, the resident vehicle controller being programmed to:
determine if the resident wireless communications device is communicatively connected to a wireless communications device of a seeder vehicle;
transmit a prompt to the seeder vehicle to initiate a resource discovery process to retrieve data from a set of remote files stored via a memory device of the seeder vehicle for storage via the resident memory device;
receive, via the resident wireless communications device from the seeder vehicle, a Bloom filter with a set of remote file IDs mapped to a bit array, each of the remote file IDs corresponding to a respective one of the remote files and having a corresponding remote file version number encoded as a multi-bit binary sequence mapped to the bit array;
determine whether or not a local file ID of an existing file stored via the resident memory device is a member of the Bloom filter, the local file ID being a member of the Bloom filter if the multi-bit binary sequence of a counterpart one of the remote file IDs is mapped to and fills each array position of the bit array assigned to the local file ID according to a calibrated hash function;
in response to the local file ID being a member of the Bloom filter, determine if the remote file version number encoded to the counterpart remote file ID and mapped to the bit array of the Bloom filter is newer than a local file version number associated with the local file ID; and
in response to the counterpart remote file being newer than the existing file, download the counterpart remote file associated with the counterpart remote file ID and stored in the memory device of the seeder vehicle to the resident memory device of the motor vehicle.

16. The motor vehicle of claim 15, wherein determining whether or not the local file ID is a member of the Bloom filter includes:
applying the calibrated hash function to map the local file ID to the bit array of the Bloom filter; and
confirming that the hash function maps the local file ID to each array position of the bit array as the counterpart remote file ID.

17. The motor vehicle of claim 15, wherein the resident vehicle controller is further programmed to, in response to a determination that the local file ID is not a member of the Bloom filter, determining if another local file ID of another existing file stored via the resident memory device of the motor vehicle is a member of the Bloom filter.

18. The motor vehicle of claim 15, wherein the resident vehicle controller is further programmed to, in response to a determination that the remote file version number is not newer than the local file version number, determining if another local file ID of another existing file stored via the resident memory device of the motor vehicle is a member of the received Bloom filter.

19. The motor vehicle of claim 15, wherein the bit array is comprised of a series of multi-bit array positions, and wherein each of the corresponding remote file version numbers is the multi-bit binary sequence assigned to one or more of the multi-bit array positions.

20. The motor vehicle of claim 19, wherein at least one of the corresponding remote file version numbers for at least one of the remote file IDs is assigned to multiples ones of the multi-bit array positions.
